(19) United States
(12) Patent Application Publication
(10) Pub. No.: US 2020/0215836 A1
(43) Pub. Date: Jul. 9, 2020

(54) LOW VISCOSITY PRINT COATING SYSTEMS AND METHODS

(71) Applicant: Georgia-Pacific Containerboard LLC, Atlanta, GA (US)

(72) Inventors: Gary Norman Boettcher, Juliette, GA (US); Rajesh Kumar Garg, Smyrna, GA (US); Carter Anderson Rechtin, St. Augustine, FL (US); William John Haskins, Bluffton, SC (US)

(21) Appl. No.: 16/720,764

(22) Filed: Dec. 19, 2019

Related U.S. Application Data
(60) Provisional application No. 62/787,848, filed on Jan. 3, 2019.

(51) Int. Cl. B41M 5/00; B41F 13/02; B05C 1/08

(52) U.S. Cl. CPC B41M 5/0011; B41F 13/025; B41M 5/5245; B05C 1/0834; B05C 1/0895

(57) ABSTRACT

Systems for applying low viscosity print coating to a web product using a coating roller and an off-press system are provided herein. An example system includes an unwinding station and a winding station. A motor causes the web product to travel along a web path. A coating roller applies a low viscosity print coating to a first side of the web product at a first position along the web path. The low viscosity print coating comprises a salt solution with a centipoise that is less than or equal to 100 centipoise that is configured to enhance printability. A backing roller applies a backing coating to a second, opposite side of the web product at a second, different position along the web path. The backing coating enhances sheet stability of the web product. A drying station dries the low viscosity print coating and the backing coating to remove moisture.

### CROSS-REFERENCE TO RELATED APPLICATION(S)

The present application claims priority to U.S. Provisional Application No. 62/787,848, entitled “Low Viscosity Print Coating Systems and Methods”, filed Jan. 3, 2019; the contents of which is incorporated by reference herein in its entirety.

### BACKGROUND

Various printing systems (e.g., printing presses) have been developed to apply ink to print one or more images (e.g., symbols, marketing indicia, product information, etc.) on web product (e.g., paper-based web product). For example, a roll of web product may pass through a printing press and receive one or more images. A print coating is often applied to the web product prior to printing to increase desired printability (e.g., increase absorption of the ink, resist bleeding of the ink, etc.). After receiving the print, the printed web product may be processed or finished into various products (e.g., boxes, sheets, folded cartons, labels, flexible paper, posters, industrial bags, plates, cups, décor, and many other things).

### BRIEF SUMMARY

Example embodiments of the present invention generally relate to coating systems for paper for enhanced printability and, more particularly, to coating systems for applying a low viscosity print coating to a roll of web product.

There is a need to apply print coating to rolls of web product (e.g., paper-based web product) prior to printing with a high volume printing press (e.g., a high volume inkjet press that processes and prints on rolls of web product). In some cases, a large roll of web product is inserted into the printing press and often the print coating is applied using a medium viscosity (e.g., 100-500 centipoise) coating while the roll of web product is being processed through the printing press (but before printing occurs). The medium viscosity coating application can be printed on using print heads or print rolls so as to keep pace in the printing press, but can be costly and complex, as it requires precise application for uniformity. In other cases, a high viscosity (e.g., greater than 500 centipoise) coating is applied using a post-meter solution that requires a rod or blade (or similar device) to remove excess moisture/coating from the web product after application. This, however, often results in non-uniform application, such as due to low or high spots of coating on the web product. Some applications apply a low viscosity (e.g., less than 100 centipoise) coating using a “spray-on” method, but such a system is complex and costly, and can create other undesirable effects (e.g., corrosiveness, uncleanliness, etc.) due to potential overspray of the coating.

Some embodiments of the present invention contemplate utilizing another application, namely a pre-metered roller application. Notably, such an application method does not work with medium or high viscosity coatings because using a coating roller can often result in undesirable effects on the web product with such coatings, as the medium-to-high viscosity coating can “split” with some of the coating being left on the coating roller—thereby creating inconsistency in the coating application and resulting in less desirable print results. However, utilizing a low viscosity solution and pre-metered coating roller “in-line” with a press is undesirable, as it does not keep up with the speed of operation of the press (which is costly to run). Thus, some embodiments of the present invention solve such problems by applying a low viscosity print coating using a separate (e.g., “off-press”) system prior to transfer of the roll of web product to the printing press. Using a separate coating system, the roll of web product can be inserted into the system and unwound. One or more coating rollers can apply the low viscosity print coating on the web product. Notably, using a low viscosity print coating provides for more even, uniform application using a coating roller (such as described above). This is even more the case when applying coating to relatively-wide (e.g., greater than 100 in.) rolls of web product, as a single coating roller can cover the entire width of the web product. In some embodiments, the low viscosity print coating can be applied using “pre-metering” to provide a uniform application of the print coating and avoid the need to post-meter the coating.

In some embodiments, the proposed print coating is formed to have a low viscosity (e.g., less than 100 centipoise or, in some cases, less than 20 centipoise, less than 10 centipoise, etc.). In some embodiments, the print coating is formed of a salt solution, such as using Calcium Chloride. However, most any cationic material may work, such as cationic polymers, cationic modified latexes, in addition to other salts, such as Magnesium or Aluminum Chloride or Sulfate. In some embodiments, an additive, such as starch, is included (e.g., a 10:1 ratio Calcium Chloride to starch). Based on testing, in some embodiments, application of the coating using a single-side thin-film coating roller results in uniform coverage of 0.5-1.0 g/m² (grams per square meter) of Calcium Chloride on a dry basis.

In some embodiments, a backing roller can apply a second, backside coating to the opposite (unprinted) side of the web product to enhance sheet stability (e.g., avoid “curl”) and improve cleanliness and efficiency when processing the roll of web product (e.g., avoid dust build-up that would occur due to flaking of the roll of web product during processing).

Further, a drying station can be used to dry the coatings to remove moisture and prepare the roll of web product for later transfer and printing. In this regard, the roll of coated web product can be rewound—thereby being ready for transfer and insertion into the printing press.

After being processed, such as on the printing press, the roll of printed web product may be processed or finished into various products (e.g., boxes, sheets, folded cartons, labels, flexible paper, posters, industrial bags, plates, cups, décor, and many other things).

In addition to the above noted benefits, some embodiments of the present invention provide the benefit that the roll of coated web product can be quality checked after completion of the coating application process without having to waste unnecessary time and materials if the quality check were to not take place or without having to stop the printing press if the quality check were to otherwise take place while the roll of web product was on the printing press. A further benefit is that there is no need to apply a bonding agent for use with a printing method (which would be utilized if the coating application occurred on the printing press).

In an example embodiment, a system for coating a roll of web product is provided. The system comprises an unwinding station comprising an unwinding device that is configured to enable unwinding of the roll of web product. The unwinding station is configured to receive the roll of web product. The system further includes a winding station that is configured to receive a tail end of the roll of web product and enable winding up of the roll of web product. The system further includes a motor configured to cause web product from the roll of web product to at least one of unwind at the unwinding station or wind at the winding station such that the web product travels along a web path from the unwinding station to the winding station. The system further includes a coating roller that is configured to apply a low viscosity print coating to a first side of the web product at a first position along the web path. The low viscosity print coating comprises a salt solution that is configured to enhance printability on the web product, wherein the salt solution has a centipoise that is less than 100 centipoise. The system further includes a backing roller that is configured to apply a backing coating to a second side of the web product at a second position along the web path. The backing coating is configured to enhance sheet stability of the web product. The first side of the web product is opposite the second side of the web product, wherein the second position is different than the first position. The system further includes a drying station positioned along the web path downstream of the coating roller and the backing roller and upstream of the winding station. The drying station is configured to dry the low viscosity print coating and the backing coating to remove moisture from the web product.

In some embodiments, the coating roller is configured to be metered with the print coating prior to application of the print coating on the web product such that the print coating is pre-metered. In some embodiments, the coating roller comprises one or more grooves configured to enable metering on the coating roller.

In some embodiments, the coating roller is configured to operate at a first variable speed with respect to a speed of the web product along the web path such that the first variable speed of the coating roller is independently controlled from the winding and unwinding of the web product. In some embodiments, the backing roller is configured to operate at a second variable speed with respect to the speed of the web product along the web path such that the second variable speed of the backing roller is independently controlled from the winding and unwinding of the web product and the first variable speed of the coating roller. In some embodiments, the system further comprises a controller configured to control operation of the coating roller at the first variable speed and control operation of the backing roller at the second variable speed. In some embodiments, the controller is configured to: receive an indication of the type of web product or a desired print quality; and determine, based on the type of web product or the desired print quality, the first variable speed or the second variable speed. In some embodiments, the controller is configured to determine the first variable speed of the coating roller such that application of the low viscosity print coating on the web product results in uniform coverage of between 0.5 and 1 grams per square meter of Calcium Chloride on a dry basis.

In some embodiments, when the first variable speed of the coating roller is slower than the speed of the web product along the web path, less of the low viscosity print coating is applied to the first surface of the web product than when the first variable speed of the coating roller is faster than the speed of the web product along the web path.

In some embodiments, the coating roller is configured to contact the web product on the first side and at the first position without another roller contacting the web product on the second side and at the first position such that no nip is formed at the first position.

In some embodiments, the backing roller is configured to contact the web product on the second side and at the second position without another roller contacting the web product on the first side and at the second position such that no nip is formed at the second position.

In some embodiments, the salt solution comprises a range of 10% to 20% Calcium Chloride.

In some embodiments, the salt solution comprises a starch additive.

In some embodiments, the salt solution comprises one of the group consisting of a cationic polymer, a cationic modified latex, Calcium Chloride, Magnesium, Aluminum Chloride, and Sulfate.

In some embodiments, the winding station is configured to wind up the roll of web product prior to printing on the web product such that application of the low viscosity print coating and backing coating on the web product occurs off-press.

In some embodiments, the unwinding station, coating roller, backing roller, drying station, and winding station are each configured to enable processing of a web product with a width of at least 100 in.

In some embodiments, the centipoise of the salt solution is less than or equal to 20 centipoise.

In another example embodiment, a system for coating and printing on a roll of web product is provided. The system comprises a coating system comprising an unwinding station comprising an unwinding device that is configured to enable unwinding of the roll of web product. The unwinding station is configured to receive the roll of web product. The coating system further comprises a winding station that is configured to receive a tail end of the roll of web product and enable winding up of the roll of web product that is coated. The coating system further comprises a motor configured to cause web product from the roll of web product to at least one of unwind at the unwinding station or wind at the winding station such that the web product travels along a web path from the unwinding station to the winding station. The coating system further includes a coating roller that is configured to apply a low viscosity print coating to a first side of the web product at a first position along the web path. The low viscosity print coating comprises a salt solution that is configured to enhance printability on the web product, wherein the salt solution has a centipoise that is less than 100 centipoise. The coating system further includes a backing roller that is configured to apply a backing coating to a second side of the web product at a second position along the web path. The backing coating is configured to enhance sheet stability of the web product. The first side of the web product is opposite the second side of the web product, wherein the second position is different than the first position. The system further includes a drying station positioned along the web path downstream of the coating roller and the backing roller and upstream of the winding station. The drying station is configured to dry the low viscosity print coating and the backing coating to remove moisture from the web product. The system further includes a printing system configured to receive the coated roll of web product and print on the first side of the coated roll of web product. The printing system is separate from the coating system.

In some embodiments, the system further comprises a quality check system configured to receive the coated roll of web product prior to the printing system receiving the coated roll of web product. The quality check system is configured to check a quality of at least one of the print coating or the backing coating on the coated roll of web product. The quality check system is separate from the printing system.

In yet another example embodiment, a method for coating a roll of web product is provided. The method comprises receiving, at an unwinding station, a roll of web product, wherein the unwinding station comprises an unwinding device that is configured to enable unwinding of the roll of web product. The method further includes receiving, at a winding station, a tail end of the roll of web product, wherein the winding station is configured to enable winding up of the roll of web product. The method further includes causing the web product from the roll of web product to at least one of unwind at the unwinding station or wind at the winding station such that the web product travels along a web path from the unwinding station to the winding station. The method further includes operating a coating roller while the web product is traveling along the web path to apply, via the coating roller, a low viscosity print coating to a first side of the web product at a first position along the web path, wherein the low viscosity print coating comprises a salt solution that is configured to enhance printability on the web product, and wherein the salt solution has a centipoise that is less than 100 centipoise. The method further includes operating a backing roller while the web product is traveling along the web path to apply, via the backing roller, a backing coating to a second side of the web product at a second position along the web path, wherein the backing coating is configured to enhance sheet stability of the web product, wherein the first side of the web product is opposite the second side of the web product, and wherein the second position is different than the first position. The method further includes drying the web product at a drying station positioned along the web path downstream of the coating roller and the backing roller and upstream of the winding station, wherein the drying station is configured to dry the low viscosity print coating and the backing coating to remove moisture from the web product.

In some embodiments, the method further comprises: removing the coated roll of web product from the winding station; providing the coated roll of web product to a printing system; and printing, via the printing system, on the first side of the web product.

In some embodiments, the method further comprises checking a quality of at least one of the print coating or the backing coating of the coated roll of web product prior to providing the coated roll of web product to the printing system.

In some embodiments, operating the coating roller comprises operating the coating roller at a first variable speed with respect to a speed of the web product along the web path such that the first variable speed of the coating roller is independently controlled from the winding and unwinding of the web product. In some embodiments, operating the backing roller comprises operation the backing roller at a second variable speed with respect to the speed of the web product along the web path such that the second variable speed of the backing roller is independently controlled from the winding and unwinding of the web product and the first variable speed of the coating roller.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a block diagram of an example paper-based manufacturing process, in accordance with some example embodiments discussed herein;

FIG. 2 shows a box diagram of an example coating system, in accordance with some example embodiments described herein;

FIG. 3 shows an example coating roller, in accordance with some example embodiments described herein; and

FIG. 4 illustrates a flowchart of an example method for applying coating to a roll of web product, in accordance with some embodiments discussed herein.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

### Example Paper-Based Manufacturing Process

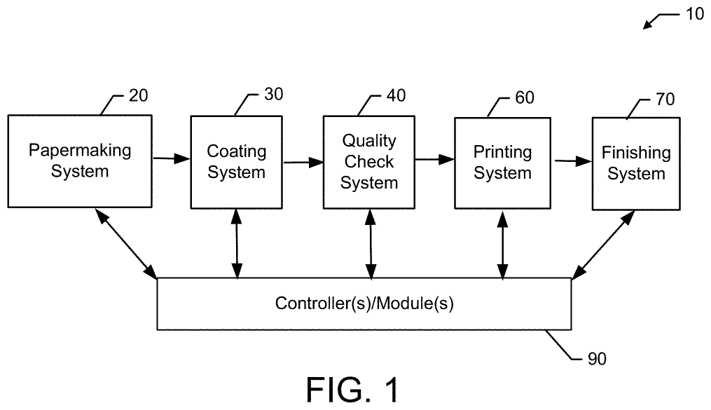

FIG. 1 illustrates an example paper-based manufacturing process 10 to form one or more paper-based products, according to various embodiments of the present invention. The manufacturing process 10 includes a number of phases/systems that may result in a finished product, such as to a customer's order. The process 10 may include a papermaking phase/system 20, a coating phase/system 30, a quality check phase/system 40, a printing phase/system 60, and a finishing phase/system 70. Applicant notes that additional phases/systems are also contemplated, including a planning phase, logistics/tracking phase, etc., but has limited the following description for purposes of explanation with respect to various embodiments of the present invention.

Depending on the desired configuration, one or more controller(s)/module(s) 90 may be used to control one or more various phases/systems (e.g., various systems/devices therein) of the manufacturing process 10. In some embodiments, less or more phases or different orders of phases are contemplated. Some embodiments of the present invention are contemplated for any type of paper-based product manufacturing, including printed paper-based product manufacturing, such as corrugate, folded carton, beverage labels, flexible paper, industrial bags, plates, cups, décor, and many others.

In the papermaking phase/system 10, a roll of web product may be formed. Such web product may be any type of paper-based web product, such as format paper, stock for liners (e.g., bleached, white top, unbleached kraft, recycled board, other liners, etc.), folding carton, plate stock, cup stock, tray stock, bag stock, among others. One or more papermaking devices/apparatuses/systems, such as through one or more controllers or modules (e.g., controller 90), may be configured to form the roll of web product. The roll of web product may define any width. In some embodiments, the roll of web product may define a width greater than 100 in.

In some embodiments, the roll of web product may be uncoated or coated. Likewise, while some embodiments disclose a papermaking phase/system 10, such as phase/system may not be used and pre-made or formed web product may be utilized. In this regard, in some embodiments, various coating phases/systems described herein may be utilized with already coated or printed web product, such that an additional coating layer is applied thereover.

During a coating phase, the roll of web product may be provided to a coating system 30 for providing coating (e.g., print coating, backing coating, etc.) thereon. Depending on the type of web product, different formulations of print coating may be applied. Similarly, different formulations of a backing coating may be applied. One or more coating systems/apparatuses/device, such as through one or more controllers or modules (e.g., controller 90), may be configured to operate to cause one or more coatings (e.g., a low viscosity print coating and/or backing coating) to be applied to the roll of web product. In some embodiments, the coating system 30 may be separate from the other phases/systems described herein (such as the printing phase/system) to enable various benefits, including efficient process control, such as described herein. Further detail regarding various example coating systems and coatings is described herein.

In the quality check phase/system 40, a roll of coated web product may be checked for errors or inconsistences. In this regard, one or more quality check devices/apparatuses/systems, such as through one or more controllers or modules (e.g., controller 90), may be configured to perform a quality check on the roll of coated web product. For example, various cameras or other sensors may image or otherwise detect errors or inconsistencies in the roll of coated web product (e.g., tears, uneven coating application, etc.). As a result, the errors or inconsistencies can be either corrected or removed, such as with a reel editor.

In some embodiments, the quality check system 40 may be separate from one or more of the coating system 30 and the printing system 60. Such embodiments may provide the benefit that the roll of coated web product can be quality checked after completion of the coating application process without having to waste unnecessary time and materials if the quality check were to not take place. For example, the printing system would not need to waste time or ink on web product that had errors on it. Additionally, such embodiments avoid the need to perform any quality checking on the printing systems, which would otherwise incur extra time or expense when running the printing system. Alternatively, in some embodiments, the quality check system/phase may be performed in conjunction with the coating system 30 and/or printing system 60.

The manufacturing process 10 may also include the printing phase/system 60. Depending on the desired manufacturing process 10, digital print processes can be used, providing for enhanced image quality. In the printing phase/system 30, one or more controllers or modules (e.g., controller 90) may be configured to direct printing of one or more images at specific locations on the web product. For example, various ink delivery devices may be used to apply ink to the web product (such as where the print coating was applied) to cause the one or more images to be printed thereon. In some embodiments, the controller 90 may utilize a control plan (e.g., reel map) to determine where on the web to print the images and/or markers. In some embodiments, the controller 90 may provide the control plan to the printer for operation thereof to cause the printer to print the desired image at an appropriate position on the roll of web product—thereby forming a roll of printed web product. Any image (including, words, marks, instructions, etc.) is contemplated by various embodiments of the present invention. In some embodiments, by having applied the coating separately from the printing phase/system 60, more efficient operation of the printing system (e.g., printing press) can be achieved.

In the finishing phase/system 70, one or more controllers or modules (e.g., controller 90) may be configured to perform one or more processes to result in a formed product (e.g., a paper-based product). Such processes may include any process and any system/device used to complete the process to form the end product. For example, the roll of printed web product may be cut into sheets and/or otherwise formed into various structures (e.g., corrugate, plates, cups, bags, etc.). Some such processes may include, for example, cutting, scoring, gluing, folding, fluting, laminating, tubing, die-cutting, among many other things, in order to form the desired end product.

As described in more detail herein, the controller 90 (or various individual controllers 90) provides logic and control functionality used during operation of various components/systems/phases of the manufacturing process 10. In some embodiments, the functionality of the controller 90 may be distributed to several controllers that each provides functionality to discrete portions of the operation of manufacturing process 10.

The controller 90 may comprise one or more suitable electronic device(s)/server(s) capable of executing described functionality via hardware and/or software control. In some embodiments, the controller 90 may include one or more user interfaces (not shown), such as for displaying information and/or accepting instructions. The controller 90 can be, but is not limited to, a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a solid-state computer, a single-board computer, a buffered computer, a computer network, a desktop computer, a laptop computer, a personal digital assistant (PDA) or a hybrid of any of the foregoing.

The controller 90 may include one or more processors coupled to a memory device. Controller 90 may optionally be connected to one or more input/output (I/O) controllers or data interface devices (not shown). The memory may be any suitable form of memory such as an EPROM (Erasable Programmable Read Only Memory) chip, a flash memory chip, a disk drive, or the like. As such, the memory may store various data, protocols, instructions, computer program code, operational parameters, etc. In this regard, controller may include operation control methods embodied in application code. These methods are embodied in computer instructions written to be executed by one or more processors, typically in the form of software. The software can be encoded in any suitable language, including, but not limited to, machine language, assembly language, VHDL (Verilog Hardware Description Language), VHSIC HDL (Very High Speed IC Hardware Description Language), Fortran (formula translation), C, C++, Visual C++, Java, ALGOL (algorithmic language), BASIC (beginners all-purpose symbolic instruction code), visual BASIC, ActiveX, HTML (HyperText Markup Language), and any combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software. In this regard, in some embodiments, the controller 90 may be configured to execute computer program code instructions to perform aspects of various embodiments of the present invention described herein.

### Example Coating System

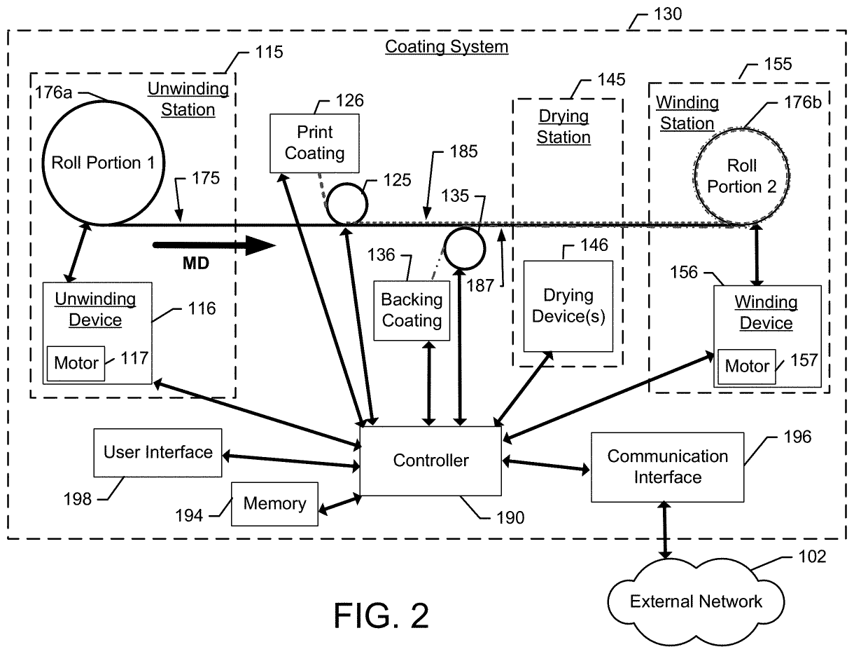

FIG. 2 illustrates an example coating system 130 for use in various embodiments of the present invention (such as for use in various example manufacturing processes 10). The illustrated coating system 130 may comprise hardware and/or software capable of performing one or more functions described herein. As discussed herein, the coating system 130 may form a separate system (e.g., machine, device, etc.) from the printing system 60 (e.g., a printing press). The coating system 130 may include a controller 190, a memory 194, a communication interface 196, a user interface 198, an unwinding station 115, a coating roller 125 (with a print coating reservoir/device 126), a backing roller 135 (with a backing coating reservoir/device 136), a drying station 145, and winding station 155.

The controller 190 may be any means configured to execute various programmed operations or instructions stored in a memory device such as one or more devices or sets of circuitry operating in accordance with software or otherwise embodied in hardware or a combination of hardware and software, thereby configuring the device or circuitry to perform the corresponding functions of the controller 190 as described herein. In this regard, the controller 190 may be configured to perform operations of the coating system described herein. In some embodiments, the controller 190 may be embodied as or as portions of the controller 90 described herein.

The memory 194 may be configured to store instructions, computer program code, web product data, and other data/information associated with the coating system 130 in a non-transitory computer readable medium for use, such as by the controller 190.

The communication interface 196 may be configured to enable connection to external systems (e.g., an external network 102, a computer server, and/or one or more other system(s)/device(s), such as from the manufacturing process 10). In some embodiments, the communication interface 196 may comprise one or more transmitters configured to transmit, for example, one or more signals according to example embodiments described herein. Likewise, the communication interface 196 may include at least one receiver configured to, for example, receive data according to example embodiments described herein. In some embodiments, the transmitter and receiver may be combined as a transceiver. In this regard, the communication interface 196 may be configured for wired and/or wireless communication. In some embodiments, the communication interface 196 may comprise wireless capabilities for WiFi, Bluetooth, or other wireless protocols.

The user interface 198 may be configured to receive input from a user and/or provide output to a user. The user interface 198 may include, for example, a display, a keyboard, keypad, function keys, mouse, scrolling device, input/output ports, touch screen, or any other mechanism by which a user may interface with the system. Although the user interface 198 is shown as being directly connected to the controller 190 and within the coating system 130, the user interface 198 could alternatively be remote from the controller 190 and/or coating system 130.

In some embodiments, any of the above described components of the coating system 130 could be remotely located. Likewise, any of the above described components of the coating system could be divided into various parts, such that the related functionality could be divided amongst the various parts.

The unwinding station 115 of the coating system 130 is configured to receive a roll of web product (e.g., roll portion 1, 176a). In some embodiments, the roll of web product may be any type of web product and may be coated or uncoated.

In some embodiments, the unwinding station 115 may comprise one or more unwinding devices 116 that are configured to cause an installed roll of web product to unwind (or wind depending on the direction of operation). Such operation may be controlled by one or more motors 117, which may be controlled, for example, by the controller 190. Although, in some embodiments, no motor 117 may be necessary (such as when the motor 157 for the winding device 156 controls winding, as described below).

The winding station 155 of the coating system 130 is configured to receive a tail end of the roll of web product and enable gathering (e.g., winding) of the coated web product roll as the roll is unwound from the unwinding station 115, receives the appropriate coatings, and dries, such as the web product travels along a web path 175. For example, as the roll of web product is processed through the coating system 130, the tail end may attach to and begin the roll portion 2, 176b. In some embodiments, the winding station 155 may include one or more winding devices 156 that are configured to cause an installed roll of web product to wind up (or unwind depending on the direction of operation). Such operation may be controlled by one or more motors 157, which may be controlled, for example, by the controller 190. Although, in some embodiments, no motor 157 may be necessary (such as when the motor 117 for the unwinding device 116 controls unwinding, as described above).

One or more motors, such as motors 117, 157, or other motors (not shown), may be configured to cause the web product to travel along a web path 175, such as along a machine direction (MD), to lead the web product past the coating roller 125, the backing roller 135, and the drying station 145. Although FIG. 2 shows an example coating system with a coating roller 125 on the top surface of the web product and a backing roller 135 on the bottom surface of the web product, other configurations are contemplated. For example, a second coating roller could be positioned to apply print coating on the bottom surface of the web product. Such a configuration may enable print coating to be formed on both surfaces of the web product, such as for dual-side printing operations. Similarly, the relative positions of the coating roller 125 and backing roller 135 could be switched such that the backing roller 135 is positioned prior to the coating roller 125 along the web path 175 and/or that the backing roller 135 applies backing coating to the top surface of the web product while the coating roller 125 applies print coating to the bottom surface of the web product.

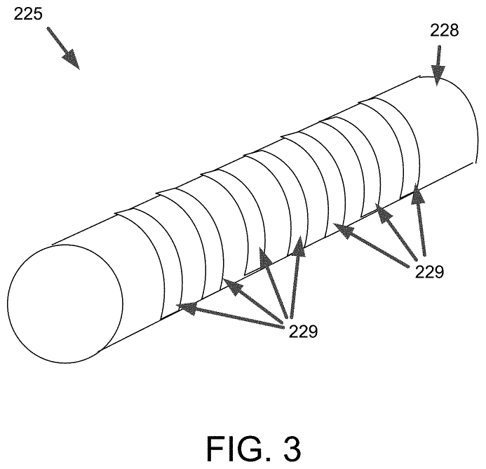

The coating roller 125 is positioned at a first position along the web path 175 and configured to apply a print coating to the web product. For example, in the illustrated embodiment, the coating roller 125 is configured to provide a print coating from the print coating reservoir/device 126 to the first (top) surface of the web product as it travels along the web path 175. In some embodiments, the coating roller 125 is configured to be metered with the print coating prior to application of the print coating on the web product such that the print coating is pre-metered (and, thus, may not need to be post-metered to remove excess residue). In some embodiments, the coating roller includes one or more grooves that may be configured to receive print coating and enable pre-metering such that there is uniform application of the print coating on the web product. FIG. 3 illustrates an example coating roller 225 that includes multiple grooves 229 in the outer surface 228, although other grooves or groove patterns known in the art are contemplated by embodiments of the present invention.

In some embodiments, the coating system 130 is configured to apply a low viscosity print coating (such as from the print coating reservoir/device 126) using the coating roller 125. In this regard, in some embodiments, the low viscosity print coating comprises a salt solution that is configured to enhance printability on the web product and has a centipoise indicative of having a low viscosity (e.g., less than or equal to 100 centipoise; less than or equal to 20 centipoise, etc.). In some embodiments, the salt solution comprises one of the group consisting of a cationic polymer, a cationic modified latex, Calcium Chloride, Magnesium, Aluminum Chloride, and Sulfate. As noted herein, utilizing a low viscosity solution for the print coating enables use of a coating roller to apply the print coating. In this regard, the low viscosity solution does not “split” and remain on the coating roller during the application process (as a medium-to-high viscosity solution often does), thereby providing uniform application at the lower cost (e.g., as compared to having to apply a medium-to-high viscosity solution using a printing or post-metering method or a low viscosity solution using a spray-on method).

In some embodiments, other additives may be included in the salt solution. For example, a starch additive may be included, such as to increase the rigidity of the web product after application thereon. An example solution may have a 10:1 ratio Calcium Chloride to starch ratio. Importantly, however, in some embodiments, the low viscosity is key to make the application of the print coating uniform using the coating roller. In this regard, in some embodiments, commonly considered “film formers”, such as higher molecular weight binders (e.g., PVA, PVAc, modified starches) may not work. In some embodiments, the solution may also include lower molecular weight additives to help surface strength and potentially help keep the applied ink nearer to the surface.

In some embodiments, the coating system 130 may be configured to vary the amount of water in the “salt solution”, such that the active ingredient (e.g., the “salt” or equivalent) falls within a range of about 10% to about 20% of the solution. In some embodiments, the coating system 130, such as through the controller 190, may be configured to determine the amount of water to apply to the composition. In some embodiments, the amount of water may be determined based on the type of web product, such as due to various absorption characteristics of the web product. In some embodiments, the amount of water in the composition may be determined so as to create uniform coverage of 0.5-1.0 grams per square meter of the active ingredient on a dry basis.

In some embodiments, the coating system 130, such as through the controller 190, may be configured to independently control the speed of operation of the coating roller 125 with respect to the speed of travel of the web product along the web path 175. For example, in some embodiments, the coating roller 125 may be configured to operate at a first variable speed with respect to a speed of the web product along the web path. In some embodiments, the coating roller 125 may be positioned along the web path 175 such that there is no corresponding roller on the opposite side of the web product so that there is no nip formed. In this regard, the web product is able to travel at a different speed than the coating roller 125. By operating the coating roller 125 at a different speed, more or less of the print coating may be applied to the web product. For example, in some embodiments, when operating the coating roller 125 at a faster speed than the web product is traveling, more of the solution remains on the surface of the web product as more surface area of the coating roller interacts with the surface of the web product. Likewise, when operating the coating roller 125 at a slower speed than the web product is traveling, less of the solution remains on the surface of the web product as less surface area of the coating roller interacts with the surface of the web product.

In some embodiments, the controller 190 may be configured to determine the formulation of the salt solution (e.g., the amount of water to apply) and the speed of operation of the coating roller in order to form a desired print coating on the web product, such as to create uniform coverage of 0.5-1.0 grams per square meter of the active ingredient on a dry basis. As noted herein, various factors, such as the type of web product, the desired print quality, etc., may be considered in determining the appropriate print coating solution and speed of operation. In this regard, some embodiments of the present invention provide an advantage of being able to adapt to the type of web product being coated on.

In some embodiments, the coating system 130 is configured to apply a backing coating (such as from the backing coating reservoir/device 136) using the backing roller 135. In some embodiments, the backing coating may be applied to a second side of the web product at a second position along the web path. In some embodiments, the second position may be different than the first position such that the print coating is applied at a different position along the web path than the backing coating. The backing coating may be configured to enhance sheet stability of the web product. For example, the backing coating may enhance sheet stability (e.g., avoid “curl”) and improve cleanliness and efficiency when processing the roll of web product (e.g., avoid dust build-up that would occur due to flaking of the roll of web product during processing). In some embodiments, the backing coating may be applied using pre-metering, such as in a similar manner to the print coating. In some embodiments, the backing coating may comprise a binder, such as cooked corn starch, synthetic latex, among others.

In some embodiments, the coating system 130 may be configured to vary the amount of water in the backing coating. In some embodiments, the coating system 130, such as through the controller 190, may be configured to determine the amount of water to apply to the backing coating composition. In some embodiments, the amount of water may be determined based on the type of web product, such as due to various absorption characteristics of the web product.

In some embodiments, the coating system 130, such as through the controller 190, may be configured to independently control the speed of operation of the backing roller 135 with respect to the speed of travel of the web product along the web path 175. For example, in some embodiments, the backing roller 135 may be configured to operate at a second variable speed with respect to a speed of the web product along the web path. Further, the backing roller 135 may be configured to operate at a different speed than the coating roller 125. In some embodiments, the backing roller 135 may be positioned along the web path 175 such that there is no corresponding roller on the opposite side of the web product so that there is no nip formed. In this regard, the web product is able to travel at a different speed than the backing roller 135. By operating the backing roller 135 at a different speed, more or less of the solution may be applied to the web product. For example, in some embodiments, when operating the backing roller 135 at a faster speed than the web product is traveling, more of the solution remains on the surface of the web product as more surface area of the backing roller interacts with the surface of the web product. Likewise, when operating the backing roller 135 at a slower speed than the web product is traveling, less of the solution remains on the surface of the web product as less surface area of the backing roller interacts with the surface of the web product.

In some embodiments, the controller 190 may be configured to determine the formulation of the backing coating (e.g., the amount of water to apply) and the speed of operation of the backing roller in order to form a desired backing coating on the web product. As noted herein, various factors, such as the type of web product, the desired sheet stability, etc., may be considered in determining the appropriate backing coating solution and speed of operation. In this regard, some embodiments of the present invention provide an advantage of being able to adapt to the type of web product being coated on.

The drying station 145 may be positioned along the web path 175 downstream of the coating roller 125 and the backing roller 135 and upstream of the winding station 155. In some embodiments, such as through one or more drying devices 146, the drying station 145 may be configured to dry the print coating and/or the backing coating to remove moisture from the web product. In this regard, the roll of coated web product can be rewound—thereby being ready for transfer to the various other systems/phases of the manufacturing process 10.

### Example Flowchart(s)

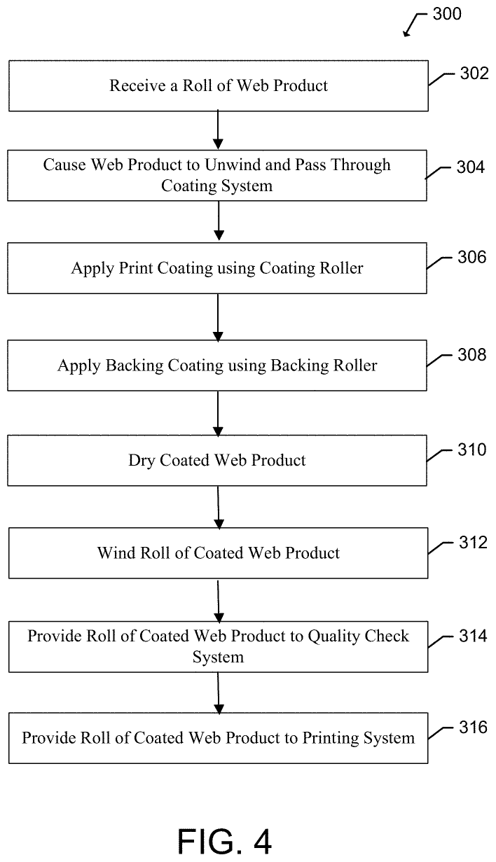

Embodiments of the present invention provide methods, apparatuses and computer program products for providing a low viscosity print coating to a roll of web product and performing various paper-based manufacturing systems according to various embodiments described herein. Various examples of the operations performed in accordance with embodiments of the present invention will now be provided with reference to FIG. 4.

FIG. 4 illustrates a flowchart according to an example method for providing a low viscosity print coating to a roll of web product and performing various paper-based manufacturing systems according to an example embodiment. The operations illustrated in and described with respect to FIG. 17 may, for example, be performed by, with the assistance of, and/or under the control of one or more of the controller 90, 190 components of the systems/phases in the described manufacturing process 10, such as the unwinding station 115, the coating roller 125, the backing roller 135, the drying station 145, the winding station 155, the controller 190, the user interface 198, the memory 194, and/or communication interface 196 of the coating system 130 described with respect to FIG. 2.

The method 300 may include receiving a roll of web product, such as at an unwinding station, at operation 302. At operation 304, the method comprises causing web product from the roll of web product to unwind and pass through the coating system. Then, the method comprises, at operation 306, applying print coating to the web product using a coating roller. At operation 308, the method comprises applying a backing coating to the opposite side of the web product using a backing roller. At operation 310, the method comprises drying the coated web product to remove excess moisture. Then, at operating 312, the method comprises rewinding the coated web product into a roll of coated web product. At operation 314, the method may include providing the roll of coated web product to a quality check system to confirm the quality of the coating. At operation 316, the method may include providing the roll of coated web product to a printing system, e.g., a printing press, to cause the roll to be printed thereon for later finishing into the desired end product.

FIG. 4 illustrates an example flowchart of systems, methods, and computer program product according to various example embodiments described herein. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory and executed by, for example, the controller 90, 190. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device to cause a series of operations to be performed on the computer or other programmable apparatus to produce a computer-implemented process such that the instructions which execute on the computer or other programmable apparatus implement the functions specified in the flowchart block(s).

### Conclusion

Many modifications and other embodiments of the inventions set forth herein may come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A system for coating a roll of web product, the system comprising:
an unwinding station comprising an unwinding device that is configured to enable unwinding of the roll of web product, wherein the unwinding station is configured to receive the roll of web product;
a winding station that is configured to receive a tail end of the roll of web product and enable winding up of the roll of web product;
a motor configured to cause web product from the roll of web product to at least one of unwind at the unwinding station or wind at the winding station such that the web product travels along a web path from the unwinding station to the winding station;
a coating roller that is configured to apply a low viscosity print coating to a first side of the web product at a first position along the web path, wherein the low viscosity print coating comprises a salt solution that is configured to enhance printability on the web product, wherein the salt solution has a centipoise that is less than 100 centipoise;
a backing roller that is configured to apply a backing coating to a second side of the web product at a second position along the web path, wherein the backing coating is configured to enhance sheet stability of the web product, wherein the first side of the web product is opposite the second side of the web product, wherein the second position is different than the first position; and
a drying station positioned along the web path downstream of the coating roller and the backing roller and upstream of the winding station, wherein the drying station is configured to dry the low viscosity print coating and the backing coating to remove moisture from the web product.

2. The system of claim 1, wherein the coating roller is configured to be metered with the print coating prior to application of the print coating on the web product such that the print coating is pre-metered.

3. The system of claim 2, wherein the coating roller comprises one or more grooves configured to enable metering on the coating roller.

4. The system of claim 1, wherein the coating roller is configured to operate at a first variable speed with respect to a speed of the web product along the web path such that the first variable speed of the coating roller is independently controlled from the winding and unwinding of the web product.

5. The system of claim 4, wherein the backing roller is configured to operate at a second variable speed with respect to the speed of the web product along the web path such that the second variable speed of the backing roller is independently controlled from the winding and unwinding of the web product and the first variable speed of the coating roller.

6. The system of claim 5 further comprising a controller configured to control operation of the coating roller at the first variable speed and control operation of the backing roller at the second variable speed.

7. The system of claim 6, wherein the controller is configured to:
receive an indication of the type of web product or a desired print quality; and
determine, based on the type of web product or the desired print quality, the first variable speed or the second variable speed.

8. The system of claim 7, wherein the controller is configured to determine the first variable speed of the coating roller such that application of the low viscosity print coating on the web product results in uniform coverage of between 0.5 and 1 grams per square meter of Calcium Chloride on a dry basis.

9. The system of claim 1, wherein the coating roller is configured to contact the web product on the first side and at the first position without another roller contacting the web product on the second side and at the first position such that no nip is formed at the first position.

10. The system of claim 1, wherein the backing roller is configured to contact the web product on the second side and at the second position without another roller contacting the web product on the first side and at the second position such that no nip is formed at the second position.

11. The system of claim 1, wherein the salt solution comprises a range of 10% to 20% Calcium Chloride.

12. The system of claim 1, wherein the salt solution comprises a starch additive.

13. The system of claim 1, wherein the salt solution comprises one of the group consisting of a cationic polymer, a cationic modified latex, Calcium Chloride, Magnesium, Aluminum Chloride, and Sulfate.

14. The system of claim 1, wherein the winding station is configured to wind up the roll of web product prior to printing on the web product such that application of the low viscosity print coating and backing coating on the web product occurs off-press.

15. The system of claim 1, wherein the unwinding station, coating roller, backing roller, drying station, and winding station are each configured to enable processing of a web product with a width of at least 100 in.

16. The system of claim 1, wherein the centipoise of the salt solution is less than or equal to 20 centipoise.

17. A system for coating and printing on a roll of web product, the system comprising:
a coating system comprising:
an unwinding station comprising an unwinding device that is configured to enable unwinding of the roll of web product, wherein the unwinding station is configured to receive the roll of web product;
a winding station that is configured to receive a tail end of the roll of web product and enable winding up of the roll of web product that is coated;
a motor configured to cause web product from the roll of web product to at least one of unwind at the unwinding station or wind at the winding station such that the web product travels along a web path from the unwinding station to the winding station;
a coating roller that is configured to apply a low viscosity print coating to a first side of the web product at a first position along the web path, wherein the low viscosity print coating comprises a salt solution that is configured to enhance printability on the web product, wherein the salt solution has a centipoise that is less than 100 centipoise;
a backing roller that is configured to apply a backing coating to a second side of the web product at a second position along the web path, wherein the backing coating is configured to enhance sheet stability of the web product, wherein the first side of the web product is opposite the second side of the web product, wherein the second position is different than the first position; and
a drying station positioned along the web path downstream of the coating roller and the backing roller and upstream of the winding station, wherein the drying station is configured to dry the low viscosity print coating and the backing coating to remove moisture from the web product; and
a printing system configured to receive the coated roll of web product and print on the first side of the coated roll of web product, wherein the printing system is separate from the coating system.

18. The system of claim 17 further comprising a quality check system configured to receive the coated roll of web product prior to the printing system receiving the coated roll of web product, and wherein the quality check system is configured to check a quality of at least one of the print coating or the backing coating on the coated roll of web product, wherein the quality check system is separate from the printing system.

19. A method for coating a roll of web product, the method comprising:
receiving, at an unwinding station, a roll of web product, wherein the unwinding station comprises an unwinding device that is configured to enable unwinding of the roll of web product;
receiving, at a winding station, a tail end of the roll of web product, wherein the winding station is configured to enable winding up of the roll of web product;
causing the web product from the roll of web product to at least one of unwind at the unwinding station or wind at the winding station such that the web product travels along a web path from the unwinding station to the winding station;
operating a coating roller while the web product is traveling along the web path to apply, via the coating roller, a low viscosity print coating to a first side of the web product at a first position along the web path, wherein the low viscosity print coating comprises a salt solution that is configured to enhance printability on the web product, wherein the salt solution has a centipoise that is less than 100 centipoise;
operating a backing roller while the web product is traveling along the web path to apply, via the backing roller, a backing coating to a second side of the web product at a second position along the web path, wherein the backing coating is configured to enhance sheet stability of the web product, wherein the first side of the web product is opposite the second side of the web product, wherein the second position is different than the first position; and
drying the web product at a drying station positioned along the web path downstream of the coating roller and the backing roller and upstream of the winding station, wherein the drying station is configured to dry the low viscosity print coating and the backing coating to remove moisture from the web product.

20. The method of claim 19 further comprising:
removing the coated roll of web product from the winding station;
providing the coated roll of web product to a printing system;
printing, via the printing system, on the first side of the web product; and
checking a quality of at least one of the print coating or the backing coating of the coated roll of web product prior to providing the coated roll of web product to the printing system.

21. The method of claim 19, wherein operating the coating roller comprises operating the coating roller at a first variable speed with respect to a speed of the web product along the web path such that the first variable speed of the coating roller is independently controlled from the winding and unwinding of the web product.
